(19) United States
(12) Patent Application Publication
(10) Pub. No.: US 2019/0210102 A1
(43) Pub. Date: Jul. 11, 2019

(54) HIGH PRESSURE ALLOY CASTING PROCESS AND APPARATUS

(71) Applicant: ARCONIC INC., Pittsburgh, PA (US)

(72) Inventors: Vivek M. Sample, Murrysville, PA (US); Men Glenn Chu, Export, PA (US); Mark T. Kruzynski, Export, PA (US); Michael Cardinale, Apollo, PA (US); Raymond J. Kilmer, Pittsburgh, PA (US); Evan C. Waitkus, Leechburg, PA (US)

(21) Appl. No.: 16/355,494

(22) Filed: Mar. 15, 2019

Related U.S. Application Data
(63) Continuation of application No. PCT/US2017/054767, filed on Oct. 2, 2017.
(60) Provisional application No. 62/406,285, filed on Oct. 10, 2016.

(51) Int. Cl. B22D 23/06; B33Y 10/00; B33Y 30/00; B23K 26/12; B23K 26/08; B23K 26/14; B23K 26/342

(52) U.S. Cl. CPC B22D 23/06; B33Y 10/00; B33Y 30/00; B23K 26/703; B23K 26/0823; B23K 26/1464; B23K 26/342; B23K 26/12

(57) ABSTRACT

An apparatus and process for formation of a multicomponent metal alloy ingot or product in which granulated metal feedstock, under a high pressure inert environment, is introduced onto a rotating platen or previously deposited layer on the rotating platen. As the granulated feedstock is deposited on the platen, the platen is rotated such that a segment of the platen having the feedstock thereon passes through an energy generator field such as a melting laser beam or eddy current induction melting field. As it passes it is melted to form an arcuate segment of melt. The melt is then rotated out from under the energy beam and cooled into a solid state of the desired alloy as a next contiguous segment of feedstock is introduced and the process repeated until a layer is formed. The platen may then be indexed lower and a new layer is formed in the same manner.

### CROSS REFERENCE TO RELATED APPLICATIONS

This application is a continuation of International Patent Application No. PCT/US2017/054767, filed Oct. 2, 2017, which claims the benefit of priority of U.S. Provisional Patent Application Ser. No. 62/406,285, filed Oct. 10, 2016, both entitled High Pressure Alloy Laser Casting Process and Apparatus, each of which is hereby incorporated by reference in its entirety.

### SUMMARY OF THE DISCLOSURE

This disclosure describes a novel apparatus and process for formation of a multicomponent metal alloy product or ingot in which metal feedstock, such as a granulated metal feedstock, under a high pressure inert environment, is introduced onto a rotating platen or previously deposited layer on the rotating platen. As the feedstock is deposited on the platen, the platen is rotated such that a segment of the platen having the feedstock thereon passes through an energy beam or field such as a melting laser beam or eddy current induction heating field. As it passes, it is melted to form an arcuate segment of melt. The melt is then rotated out from under the laser beam or field and cooled into a solid state of the desired alloy as a next contiguous segment of feedstock is introduced onto the platen, passed into the beam or field, melted, then cooled, until a complete layer of solidified desired alloy is formed. The platen is then indexed lower and a new layer is formed in the same manner.

The melting of each segment is essentially a continuous process wherein the platen is rotated continuously through a full rotation of 360 degrees to form each layer of the desired alloy. The laser beam or induction field preferably melts the granular layer segment as well as an immediately underlying previous layer of the desired alloy. Alternatively, within the pressurized chamber, each layer may be formed by utilizing a movable melting laser array focused on a stationary or fixed platen to provide relative rotation between the platen and the laser array.

A predetermined amount of the granulated component mixture is preferably introduced in a melting section of a pressurized chamber such that the mixture is evenly spread over a segment of a circular surface. The segment is then passed through a laser scan area or eddy current induction field on the surface to melt the granulated mixture into a melt. As the melt on the surface moves out of the laser scan area the melt solidifies into the desired alloy. Pressure may be maintained at a high level within the chamber to suppress boiling of the applicable or all component elements in the alloy.

As used herein, “multi-component alloy product” and the like means a product with a metal matrix, where at least four different elements making up the matrix, and where the multi-component product comprises 5-35 at. % of the at least four elements. In one embodiment, at least five different elements make up the matrix, and the multi-component product comprises 5-35 at. % of the at least five elements. In one embodiment, at least six different elements make up the matrix, and the multi-component product comprises 5-35 at. % of the at least six elements. In one embodiment, at least seven different elements make up the matrix, and the multi-component product comprises 5-35 at. % of the at least seven elements. In one embodiment, at least eight different elements make up the matrix, and the multi-component product comprises 5-35 at. % of the at least eight elements. As described below, additives may also be used relative to the matrix of the multi-component alloy product.

### BRIEF DESCRIPTION OF THE DRAWING

FIG. 1 is a schematic representation of an exemplary apparatus in accordance with the present disclosure.

### DETAILED DESCRIPTION

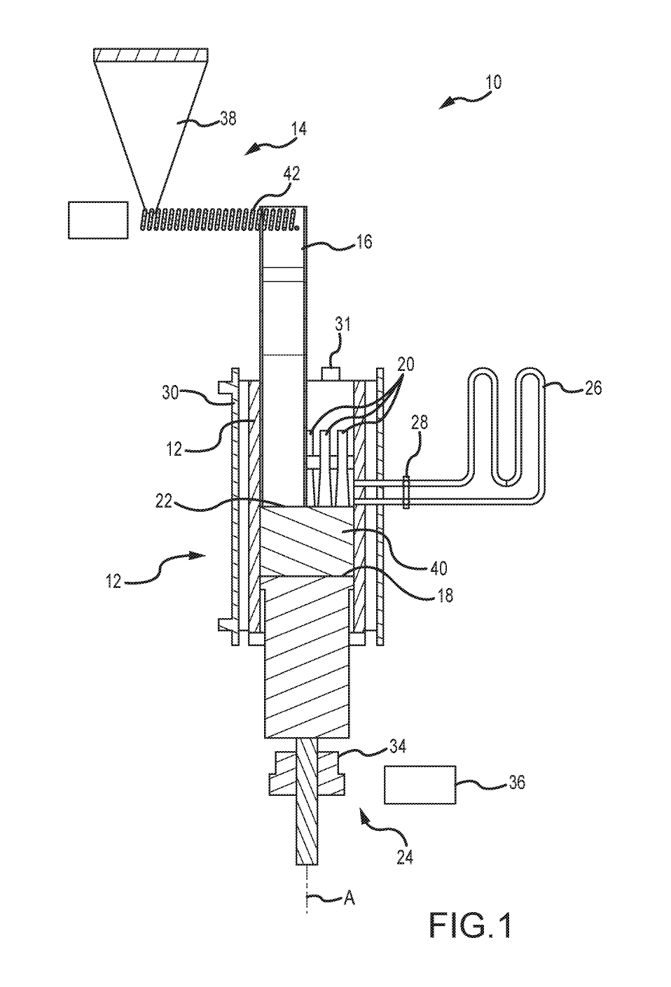

An apparatus for forming a multicomponent metal alloy from granulated metal feedstock in accordance with one exemplary embodiment of the current disclosure is shown in FIG. 1. The apparatus 10 includes a pressure chamber 12 capable of withstanding a chamber gas pressure between 0 psia and at least 1015 psia, a feedstock supply 14 connected to the chamber 10 at chamber pressure for depositing granulated feedstock 16 onto a rotatable platen 18 within the chamber 10, one or more energy beam or electromagnetic field sources such as melting lasers 20 operable to focus laser light energy onto the rotating platen 18 in the chamber 10 sufficient to melt granulated feedstock 16 deposited in a layer 22 on the rotating platen 18, and a platen positioning mechanism 24 operable to rotate the platen 18 about an axis and move the platen 18 in an axial direction.

Note that in FIG. 1, the apparatus 10 is shown with an ingot 40 already partially formed on the platen 18. The current layer 22 being melted and cooled is shown directly beneath the lasers 20. During formation of a layer 22 the melt laser 20 actually melts the feedstock 16 forming the layer 22 as well as the immediately underlying layer of previously formed multicomponent alloy ingot 40 on the platen 18. In this manner, a preselected compositional structure of the ingot 40 is produced. In one embodiment, the preselected compositional structure is uniform/homogenous. In another embodiment, the preselected compositional structure in non-homogenous.

Preferably the apparatus 10 includes a heat exchanger 26 connected to the pressure chamber 12 for recirculating and cooling gas from and to the pressure chamber 12. A filter 28 is preferably positioned in a pathway between the heat exchanger 26 and the pressure chamber 12 for removing particulates and other contaminants from the gas as it is recirculated back to the pressure chamber 12. This filter 28 may also include an oxygen absorber for removing off-gassed oxygen molecules to keep the internal chamber environment oxygen free during operation. The pressure chamber 12 may be preferably cylindrical in shape with a water cooled jacket 30 surrounding the chamber 12. The chamber 12 preferably has a tubular portion housing the platen 18 upon which an ingot 40 of desired multicomponent alloy is formed. This tubular portion has a central axis A about which the platen 18 is rotated by the platen positioning assembly 24. The platen positioning assembly 24 includes a rotator 34 and an axial indexing mechanism 36.

The feedstock supply 14 is preferably connected to the pressure chamber 12 and maintained at the same pressure as the pressure chamber 12. The feedstock supply 14 preferably includes a sealable hopper 38 and a feed mechanism such as a screw feeder 42 for dispensing feedstock onto the platen 18 (e.g., at a uniform rate) so that the granular feedstock 16 is deposited (e.g., in a uniform thickness) continuously growing radial segment fashion on the rotating platen 18.

The one or more energy beams such as melting lasers 20 are arranged so as to focus a radial strip or beam of light energy onto the feedstock 16 deposited onto the platen 18 as the feedstock passes beneath the beam of light energy. The melting lasers 20 may be contained within the chamber 12 or may be situated outside the chamber 10 and arranged to project the light beam through a suitable window 31 in the wall of the chamber 12 onto the surface of the platen 18.

The lasers 20 melt the feedstock within the beam segment, and, as the melt formed in an arcuate segment on the platen 18 rotates away from the beam, the melt begins to solidify. As the platen 18 is further rotated, the solidified melt cools to form a solid segment of a layer 22 of desired multicomponent alloy. Once the platen 18 is rotated through an arc of 360 degrees, a complete layer 22 of the ingot 40 is formed. The axial indexing mechanism 36 then indexes the platen 18 axially away from the previous axial position (e.g., in an amount equivalent to a preselected layer thickness) and the deposition, melting and cooling process repeats (e.g., continuously) to form the next layer of the ingot 40.

A process for casting a multicomponent metal alloy in accordance with the present disclosure comprises forming, in a pressurized chamber 12, a partial layer 22 of granulated feedstock metal 16 on a surface of a movable platen 18, melting the partial layer with an energy source such as one of a melting laser 20 or eddy current induction field to form a melt on the surface, moving the surface of the platen 18 away from beam from the laser 20, cooling the melt on the surface into a solid form multicomponent metal alloy, and repeating the forming, melting, moving and cooling operations to complete a layer 22, and then axially moving the platen 18 and repeating the above operations to produce a desired solid multicomponent metal ingot 40.

Initial preparation involves first loading the feedstock hopper 38 with an appropriate amount of granulated feedstock metal material and then sealing the hopper 38 as it is connected to the pressure chamber 12. Granulated components of a desired alloy are physically mixed to obtain the desired alloy chemistry in the feedstock. The granulated components may include elemental mixtures or pre-alloys provided to reduce the maximum melting point of the granulated feedstock 16.

Next, all air from the pressure chamber 10 may be removed by drawing a high vacuum on the chamber 10 and connected feedstock supply 14 down to a pressure of about 10⁻² millitorr. Once all the air is removed, the chamber 12 is filled preferably with an inert gas, such as argon, and/or nitrogen, to a preselected pressure within the chamber 12 (e.g., a pressure greater than any perceived feedstock constituent boiling point pressure) while under the direct exposure to the melting lasers 20.

Next a radial beam of energy such as melting laser light is focused onto the platen 18 via the lasers 20. Then granulated feedstock 16 is introduced onto the rotating circular platen 18 at a controlled rate so as to form a uniform radial segment of a layer of feedstock 16 on the platen 18. As the platen 18 is rotated, this feedstock segment passes into/through the beam of laser light and is melted, preferably along with a previously deposited layer portion directly beneath. As the melt so formed passes out of the focused beam, the melt begins to solidify into a solid multicomponent alloy. This process continues as the platen 18 is rotated. Upon further rotation through a full arc of 360 degrees, a complete layer of desired multicomponent alloy is formed.

The indexing mechanism 36 is then actuated to axially move the platen (e.g., a distance equal to the thickness of the solidified melt). The deposition of feedstock, melting, and cooling operations are repeated through another 360 degrees of rotation of platen 18, followed by another indexing of the platen 18, until a complete ingot 40 or tailored additively manufactured product is formed.

During this repetitive process, a portion of the inert pressurizing gas within the pressure chamber 12 is preferably continually circulated out of the chamber 12, through a filter 28 and heat exchanger 26, and returned to the chamber 12 to maintain the temperature within the chamber 12 sufficient to support cooling of the melt within the chamber as the melt passes out from beneath the laser beam. Also, the cooling water jacket 30 around the pressure chamber 12 aids in cooling the ingot 40 as it is being formed.

Although an array of melting lasers 20 is described with embodiments of the present disclosure, other energy sources and mechanisms for achieving localized melting may alternatively be utilized in the process and apparatus described above. For example, a suitable thermal induction array could be utilized that has the capability of targeting energy at a sufficient energy density in a similar fashion as the laser array. Such an induction array could be compatible with the high pressure chamber environment.

A further embodiment in accordance with the present disclosure is similar to embodiment 10 described above except that different feedstock 16 with a different composition may be sequentially introduced into the hopper 38 with each revolution of the platen 18 in sequence such that an axial gradient of composition layers may be deposited onto the platen 18 in the pressure chamber 12 such that the ingot 40 may have an axially varying composition; in this embodiment, the ingot 40 may be considered a compositionally tailored additively manufactured product.

Furthermore, the layers on the platen 18 may be configured to form a part of a final object rather than an ingot 40, with different feedstock being applied at different points on the platen 18 or upon different passes of the platen 18 or prior layers deposited beneath the melting lasers 20 illumination area. In this manner a multilayer multicomponent object may be formed with predetermined specific multicomponent compositions or composition gradients within the pressure chamber 12.

Described above are embodiments utilizing a movable platen and a fixed array of energy generation sources such as one or more melting lasers or eddy current induction field beam generators. Alternatively, the platen may be held in position and the energy sources such as the melting laser array described above can be movable so as to provide relative rotation and translative movement between the platen and laser array. Furthermore, the feedstock may be a granulated alloy, elemental powder, a powdered pre-alloy, a mix of rod and chips or combination of foil, wire and/or granules. In an additive printer application, the feedstock may be introduced as a pre-alloyed powder or wire in a powder bed, Sciaky wire style or optomec spray style. If the laser array has sufficient power, the feedstock may be introduced in thin sheet form so as to create a melt pool deep enough to allow for complete mixing/intermixing so as to form a desired multicomponent alloy product. At the same time the melt is formed, active mixing may be employed to ensure the melt is thoroughly mixed.

While various embodiments of the new technology described herein have been described in detail, it is apparent that modifications and adaptations of those embodiments will occur to those skilled in the art. It is to be expressly understood that such modifications and adaptations are within the spirit and scope of the presently disclosed technology.

1. A system for casting a multicomponent metal alloy comprising:
a gas filled pressure chamber capable of maintaining a pressure sufficient to prevent boiling of any feedstock component introduced into the pressure chamber;
a movable platen assembly having a movable platen within the pressure chamber;
a feedstock supply connected into the pressure chamber operable to feed feedstock under chamber pressure into the chamber and onto a surface on the movable platen;
one or more energy generators such as melting laser beams or electromagnetic induction melt fields within the pressure chamber focused on the surface on the movable platen operable to melt the feedstock beneath the beam or field focused on the surface; and
a mechanism connected to the movable platen assembly to move the melt on the surface away from the laser focused on the surface to permit cooling and solidification of the melt in the pressure chamber into a multicomponent metal alloy layer on the surface on the movable platen.

2. The system according to claim 1 wherein the pressure chamber is first evacuated to remove substantially all air from the chamber and then filled with a preselected gas.

3. The system according to claim 2 wherein the pressure chamber is maintained at a pressure greater than a boiling pressure for any feedstock component metal or alloy.

4. The system according to claim 1 wherein the pressurized chamber includes a tubular portion containing the movable platen.

5. The system according to claim 4 wherein the movable platen includes a circular head end of a piston and the mechanism includes a rotator connected to the piston and wherein the mechanism utilizes gravity to assist withdrawing the piston from the tubular portion of the pressure chamber.

6. The system according to claim 1 further comprising a cooling system connected to the pressure chamber for circulating pressurized gas from the chamber through a heat exchanger and back to the chamber to cool melt formed on the surface of the platen.

7. The system according to claim 1 further comprising a water cooling chamber around the pressure chamber to assist in cooling the chamber and the multicomponent layer being formed within the chamber.

8. The system according to claim 1 wherein the feedstock supply comprises a closable feedstock hopper at the pressure chamber pressure containing the feedstock and a feeder assembly operable to provide a controlled feed rate of feedstock onto the surface on the platen for melting.

9. The system according to claim 1 wherein the energy generators comprise one or more melting lasers focused on a radius across the surface of the platen.

10. The system according to claim 9 wherein the movable platen is rotated about an axis through the platen beneath the one or more melting lasers and the one or more lasers each melt an arcuate segment of feedstock on the surface.

11. A process for casting a multicomponent metal alloy comprising:
forming, in a pressurized chamber, a partial layer of feedstock metal on a surface of a movable platen;
melting the partial layer with an energy generator such as a melting laser beam or eddy current induction field to form a melt on the surface;
moving the surface on the platen away from the beam or field;
cooling the melt on the surface into a solid form multicomponent metal alloy; and
repeating the forming, melting, moving and cooling operations to produce a desired solid multicomponent metal product.

12. The process according to claim 11 wherein the pressurized chamber is pressurized with an inert gas.

13. The process according to claim 11 wherein the forming includes spreading feedstock onto a rotating portion of the surface on the movable platen.

14. The process according to claim 13 wherein moving comprises rotating the platen about a longitudinal axis through a tubular portion of the pressurized chamber.

15. The process according to claim 14 wherein moving comprises withdrawing the platen along the longitudinal axis as the product is formed.

16. The process according to claim 11 wherein cooling comprises circulating pressurized gas from the pressurized chamber through a heat exchanger.

17. The process according to claim 11 wherein cooling comprises rotating the platen to move the melt away from an area directly aligned with the one or more melting lasers.

18. The process according to claim 17 wherein forming comprises feeding feedstock metal onto the surface of the platen as it is being formed on the movable platen such that the product is spirally built up of sequential layers of solidified multicomponent metal.

19. An apparatus for forming a multicomponent metal alloy product from metal feedstock, the apparatus comprising:
a pressure chamber capable of withstanding a chamber gas pressure between 0 psia and at least 1015 psia;
a feedstock supply connected to the chamber at chamber pressure for depositing feedstock onto a rotating circular platen within the chamber;
one or more melting lasers or eddy current induction field generators operable to focus energy onto the rotating platen sufficient to melt the feedstock deposited in a layer on the rotating platen; and
a platen positioning mechanism operable to rotate the platen about an axis and move the platen in an axial direction.

20. The apparatus according to claim 19 further comprising a heat exchanger connected to the pressure chamber for recirculating and cooling gas from and to the pressure chamber.
